(19) United States
(12) Patent Application Publication
(10) Pub. No.: US 2013/0181048 A1
(43) Pub. Date: Jul. 18, 2013

(54) METHOD AND APPARATUS FOR STORING AND TRACKING INFORMATION RELATING TO A MEDICAL IMPLANT DEVICE

(71) Applicants: Xiaoyu Liu, Pittsburgh, PA (US); Ajay Ogirala, Pittsburgh, PA (US); Marlin Homer Mickle, Pittsburgh, PA (US); J. Lee Berger, Franklin Lakes, NJ (US)

(72) Inventors: Xiaoyu Liu, Pittsburgh, PA (US); Ajay Ogirala, Pittsburgh, PA (US); Marlin Homer Mickle, Pittsburgh, PA (US); J. Lee Berger, Franklin Lakes, NJ (US)

(73) Assignee: University of Pittsburgh-of the Commonwealth System of Higher Education, Pittsburgh, PA (US)

(21) Appl. No.: 13/552,225

(22) Filed: Jul. 18, 2012

Related U.S. Application Data
(60) Provisional application No. 61/509,169, filed on Jul. 19, 2011.

(51) Int. Cl. G06K 19/07

(52) U.S. Cl. CPC G06K 19/0723
USPC 235/439; 235/492

(57) ABSTRACT

A system for storing information relating to a medical implant device implanted in a patient includes a credit card sized card device structured to be carried by the patient external to the patient's body. The card device includes a wireless transponder device securely storing information relating to at least one of the medical implant and the patient. The system also includes a reader device structured to selectively and securely read the information from the wireless transponder device. In one implementation, the reader device is able to selectively and securely read the information from the wireless transponder device using a direct electrical connection (e.g., using transcutaneous contact) without an air interface.

### CROSS-REFERENCE TO RELATED APPLICATIONS

This application claims priority under 35 U.S.C. §119(e) from provisional U.S. patent application No. 61/509,169, filed Jul. 19, 2011, the contents of which are incorporated herein by reference.

### BACKGROUND OF THE INVENTION

1. Field of the Invention

The present invention pertains to medical implant devices, such as orthopedic implants, cardiac implants, dental implants, general surgical implants, neurological implants, gastrointestinal implants, urological implants, gynecological implants, or some other implantable medical device, and, in particular, to a card device that is associated with a medical implant patient that includes a wireless transponder for storing information relating to the medical implant and/or the patient.

2. Description of the Related Art

U.S. Pat. Nos. 7,333,013 and 7,932,825 describe a system wherein a medical implant device, such as, without limitation, an orthopedic (e.g., an artificial knee or hip) or cardiac implant (e.g., a pacemaker), has a radio frequency identification (RFID) tag mounted thereto. The RFID tag stores information relating to the implant and/or the patient, such as, without limitation, the implant type/model/serial number, the implant manufacturer, the procedure date, the hospital and/or the implanting surgeon. That information may later be obtained from outside of the patient's body when needed by reading the RFID tag using a properly equipped RFID reader device. For example, that information can be read by the surgeon or another healthcare professional during a post operative or later visit in order to obtain information needed by that individual during the visit in order to properly examine and treat the patient. As another example, that information can also be read and transmitted to a secure patient database for use in medical outcomes research performed by, for example, a healthcare organization or implant manufacturer.

In one particular implementation, described in U.S. Pat. Nos. 7,333,013 and 7,932,825, the RFID tag mounted to the implant is a passive RFID tag that includes an antenna, and may be read using a conventional RFID reader that is structured to read the implanted passive RFID tag over an air interface. In another particular implementation, an alternative RFID reader may be used, wherein the RFID reader is structured and configured to read the implanted RFID tag by making a direct (i.e., non-air interface) electrical connection to the RFID tag through the patient's living tissue using a probe provided as part of the RFID reader device (i.e., using transcutaneous contact and transcutaneous near field communication (TNFC)). This latter implementation is described in U.S. Pat. Nos. 6,487,844, 7,228,183 and 7,825,807.

Before such an implanted tag can be actually used in a patient in the United States, it must cleared by the FDA. Such clearances take time, and it would be desirable to get outcomes research started during the period where FDA clearance is pending. In addition, it would also be desirable to be able to readily collect the same information from implant patients (past or future) that have a medical implant device without an implanted RFID tag as described above. There is thus a need for a device that will facilitate the collection of surgical implant information and the commencement of related outcomes research.

### SUMMARY OF THE INVENTION

In one embodiment, a system for storing information relating to a medical implant device implanted in a patient is provided that includes a card device structured to be carried by the patient external to the patient's body. The card device includes a wireless transponder device securely storing information relating to at least one of the medical implant and the patient. The system also includes a reader device structured to selectively and securely read the information from the wireless transponder device.

In another embodiment, a card device for storing information relating to a medical implant device implanted in a patient is provided that includes a main body structured to be carried by the patient external to the patient's body, and a wireless transponder device carried by the main body, the wireless transponder device securely storing information relating to at least one of the medical implant and the patient and being structured to be selectively and securely read by a reader device.

In still another embodiment, a method for storing information relating to a medical implant device implanted in a patient is provided that includes securely storing information relating to at least one of the medical implant and the patient in a wireless transponder device carried by a card device structured to be carried by the patient external to the patient's body, and selectively and securely reading the information from the wireless transponder device using a reader device.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a block diagram of a system for storing information relating to a medical implant that has been surgically implanted in a patient according to an exemplary embodiment of the present invention;

FIG. 2 is a schematic representation of one particular exemplary embodiment of an RFID transponder device that may be employed in an implant card to implement the system of FIG. 1;

FIG. 3 is a block diagram of one particular exemplary embodiment of an RFID reader device that may be used to implement the system of FIG. 1;

FIG. 4 is a schematic representation of one particular, non-limiting embodiment of an RFID transponder wherein passive technology in the form of energy harvesting is employed to power the device;

FIGS. 5, 6 and 7 are schematic representations of RFID transponder devices according to alternative particular exemplary embodiments that may be employed in an implant card to implement the system of FIG. 1; and

FIG. 8 is a front isometric view of an implant card according to one particular embodiment of the present invention.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

FIG. 1 is a block diagram of a system 2 for storing information relating to a medical implant 4 (such as an artificial knee shown schematically in the illustrated embodiment) that has been surgically implanted in a patient 6 according to an exemplary embodiment of the present invention. As seen in FIG. 1, system 2 includes a credit card sized implant card 8 that is associated with patent 6 and that may be readily carried by patient 6 (e.g., in that patient's wallet or purse). Implant card 8 has an RFID transponder device 10 fixedly coupled thereto. RFID transponder device 10 may, in various embodiments, be a passive or active RFID tag device, and a number of particular embodiments of suitable RFID transponder devices 10 are described in detail herein (it being understood, however, that such particular embodiments are exemplary only and that other wireless transponder device configurations are also possible within the scope of the present invention). RFID transponder device 10 stores information relating to medical implant 4 and/or patient 6, such as, without limitation, the implant type/model/serial number, the implant manufacturer, the procedure date, the hospital where the procedure was performed, the implanting surgeon (and contact information for that surgeon), information relating to the procedure, such as indications for the implantation, pre-operative patient conditions (e.g., range of motion), procedure description and surgical approach, anesthesia information (e.g., anesthetics used and the name of the anesthesiologist), intra operative events, post operative medications and/or treatments, follow-up examination details by a physician, a physical therapist or an ancillary health care provider, and/or patient identifying information (such as name, gender, date of birth, contact information and patient insurance information). In the preferred embodiment, the information is loaded into RFID transponder device 10 by an RFID reader device 12, described below, although other means for loading information into RFID transponder device 10 are also possible. In addition, information may be transmitted (wired or wirelessly, and possible through an intermediate computer such as a PC) to RFID reader device 12 from a separate device such as internal (within the body) or external sensor (e.g., a joint motion sensor, an accelerometer, a temperature sensor, a blood pressure sensor, an external glucose monitor, an external cardiac monitor, an external electrolyte monitor, an external chemical monitor, an external pressure monitor, an external microorganism monitor, an external bacterial monitor, a viral monitor, or transcutaneous monitoring system) and then loaded into RFID transponder device 10 for storage thereby. Such information may also be loaded into RFID transponder device 10 by other means.

As noted above, system 2 also includes an RFID reader device 12. RFID reader device 12 and RFID transponder device 10 are structured and configured to work cooperatively so that information can be selectively read from and/or written to the memory of RFID transponder device 10 by RFID reader device 12. While any suitable RFID reader device 12 that is compatible with the RFID transponder device 10 of implant card 8 may be employed within the scope of the present invention, one particular embodiment thereof is described in detail herein that is structured and configured to read RFID transponder device 10 of implant card 8 by making a direct (i.e., non-air interface) electrical connection thereto using a probe provided as part of RFID reader device 12. In addition, in the exemplary embodiment, the information is securely stored in RFID transponder device 10 and can only be read by a properly configured RFID reader device 12 meant to be associated with RFID transponder device 10.

As seen in FIG. 1, system 2 further includes an outcomes computer system 14 that is operatively coupled to a secure patient database 16 for storing information relating to a plurality of medical implants like medical implant 4 such that outcomes information can be recorded and analyzed relating to the plurality of medical implants and the medical procedures relating thereto. Outcomes computer system 14 is operatively coupled (by a suitable wireless or wired connection or some combination thereof) to RFID reader device 12 such that information collected by RFID reader device 12 may be transmitted to outcomes computer system 14 for storage in secure patient database 16. Outcomes computer system 14 may be located in close proximity to RFID reader device 12 or may be located remotely therefrom. In the case of the latter, one or more intermediate computer devices and/or systems (not shown) may be employed to transmit the information to outcomes computer system 14 using, for example, a network like the Internet. In addition, RFID reader device 12 may also have a built in WiFi or other wired or wireless communication system to convey the information of the system to a computing device such as a tablet computer, a smartphone, a laptop computer or a PC.

Furthermore, patient 6 may be a current patient wherein patient 6 is provided with implant card 8 (having RFID transponder device 10 loaded with the appropriate information for the patient and his or her implant) at or around the time of his or her surgical procedure. Alternatively, patient 6 may be an existing patient that in the past had a medical implant 4 surgically implanted into his or her body and that now, at a later date, is obtaining implant card 8 (having RFID transponder device 10 loaded with the appropriate information for the patient and his or her implant). In either case, in the exemplary embodiment, when implant card 8 is first provided to patient 6, the information stored on RFID transponder device 10 is transmitted to outcomes computer system 14 and secure patient database 16. In the exemplary embodiment, this is done by reading RFID transponder device 10 of implant card 8 and transmitting that information to outcomes computer system 14 as described elsewhere herein. However, it will be appreciated that other mechanisms for transmitting the information stored on RFID transponder device 10 to outcomes computer system 14 and secure patient database 16 are also possible. For example, that information may be stored on RFID reader device 12 or a computer system associated with RFID reader device 12 and transmitted to outcomes computer system 14 without reading it from RFID transponder device 10 at that time.

In addition, at any time thereafter, when it is necessary to obtain information (such as the implant manufacturer, the implant model and size, and/or where the surgery was performed and by which surgeon) about implant device 4 of patient 6, such as when implant device 4 and/or patient 6 needs to be examined by a treating physician or surgeon, that information can be immediately obtained by reading RFID transponder device 10 using RFID reader device 12. The obtained information may be displayed on a display forming part of RFID reader device 12, or on a computer device or system coupled to RFID reader device 12. Also, additional information can be stored in RFID transponder device 10 as needed. For example, at the time of an examination (such as a post operative visit) as just described, patient clinical information, such as, without limitation, a record of the visit, patient symptoms, the condition of the implant, treatments provided and/or results of such treatments, can be stored onto RFID transponder device 10 so that that information may be obtained at a later date. Also, at the end of the examination, the new information stored on RFID transponder device 10 can be transmitted to outcomes computer system 14 and secure patient database 16 in the manner described above.

In addition, in the exemplary embodiment, medical implant 4 itself does not have an RFID tag mounted thereto. It will be understood, however, that this is not meant to be limiting, and that medical implant 4 may have an RFID tag mounted thereto as described elsewhere herein (U.S. Pat. Nos. 7,333,013 and 7,932,825), wherein the implanted RFID tag may also be read by RFID reader device 12. In such a case, the implanted RFID tag will store some or all of the same information as RFID transponder device 10, and either may be selectively read by and written to RFID reader device 12.

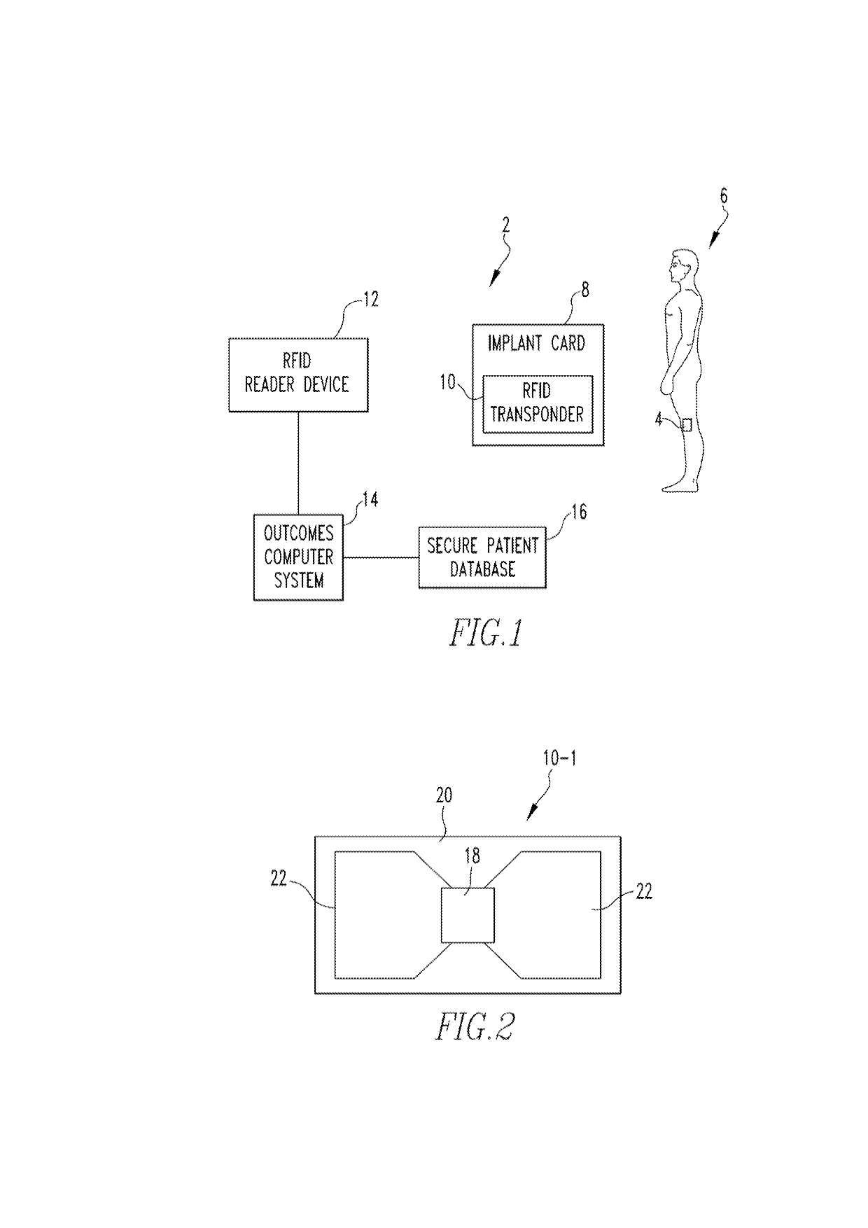

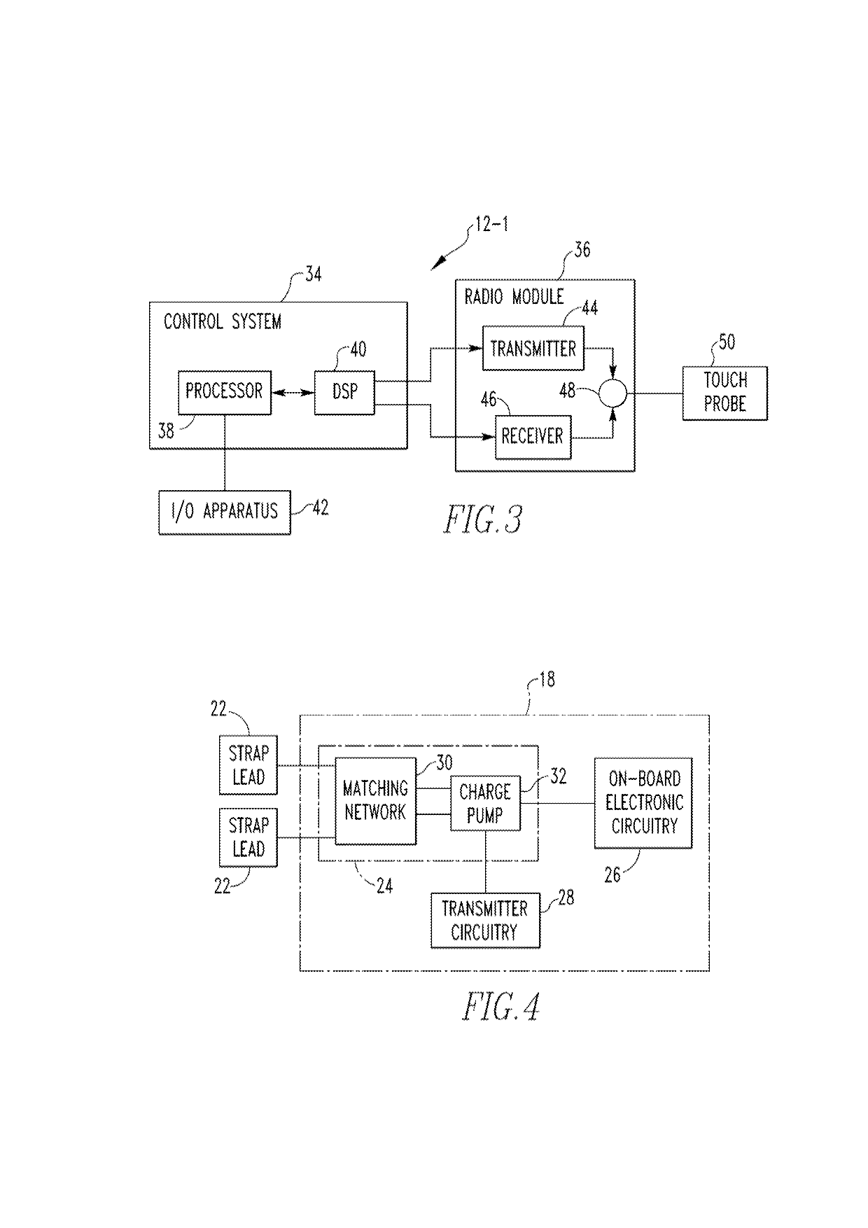

FIG. 2 is a schematic representation of one particular exemplary embodiment of an RFID transponder device 10, labeled 10-1, that may be employed in implant card 8 to implement system 2. In addition, FIG. 3 is a block diagram of one particular exemplary embodiment of an RFID reader device 12, labeled 12-1, that may be used to implement system 2 in combination with RFID transponder device 10-1 so that RFID transponder device 10-1 can be read and/or written to by making a direct (i.e., non-air interface) electrical connection thereto (e.g., using TCNC). Both RFID transponder device 10-1 and RFID reader device 12-1 are described in detail below.

Referring to FIG. 2, RFID transponder device 10-1 is in the form of what is commonly known as an RFID strap. More particularly, as is known, RFID tags typically contain an integrated circuit chip and an antenna that are connected together to form an electrical circuit that responds to certain transmitted radio frequency (RF) signals. The integrated circuit chip has very small attachment points, commonly referred to as pads, to which the antenna must be electrically connected. Such pads are typically square surfaces with less than 100 μm per side. Antennas used in RFID applications typically have conductors that must be connected to the pads of the integrated circuit chip that have widths of much greater than 100 μm. This difference in relative size makes the manufacture of RFID devices difficult. Thus, as a manufacturing aid, an intermediate fabrication step is frequently employed where an intermediate component is first formed by attaching the integrated circuit chip to relatively short interfacing conductors that have a first end that is much larger than 100 μm and a second end that is sized to accommodate the smaller pads of the integrated circuit chip. This intermediate component that includes the chip and the interfacing conductors is commonly referred to as a strap. In the final manufacturing steps of a conventional RFID tag, the strap is attached to the antenna, and both are placed on some form of a substrate. The combination of a strap and an antenna on a substrate is commonly referred to as an inlay. The inlay may later be attached to a label or the like to form an RFID tag that may be attached to a product or item in order to track and/or communicate with the product or item using RF signals.

Thus, as used herein, the term “strap” shall refer to an intermediate RF component that includes an integrated circuit chip operatively coupled to one or more interfacing conductors, either or both of which may (although not necessarily) be mounted on and supported by a substrate, wherein the interfacing conductors have a first end that is sized to accommodate the smaller pads of the integrated circuit chip and a second end that is typically larger than the first end to, for example, allow easy connection to another component such as an antenna.

Referring again to FIG. 2, RFID transponder device 10-1 in the present embodiment in the form of a strap includes a chip 18 having chip contacts (not shown) that is mounted on and supported by a strap substrate 20. Strap substrate 20 may be made of any of a variety of suitable materials, such as, for example, suitable flexible polymeric materials like PET, polypropylene or other polyolefins, polycarbonate, or polysulfone. Chip 18 may be any of a variety of suitable electronic components for electrically coupling to and suitably interacting with an RFID reader as described herein to, for example, receive and/or to send signals. The contacts of chip 18 are electrically coupled to strap leads 22 that are provided on strap substrate 20. Strap leads 22 may be made out of an electrically conducting material, such as, without limitation, a metal foil, a metal/conductive ink or a conductive polymer. In some embodiments, strap leads 22 may include an electrically insulating material along selected portions of the conducting material. Alternatively, strap leads 22 may include a dielectric material with conductive layers on one or both sides.

Normally, as described elsewhere herein, strap leads 22 are operatively coupled, through a suitable electrically-conductive connection, to an antenna provided on a substrate to form an inlay and thus form an RFID tag. However, according to the present embodiment, RFID transponder device 10-1 in the form of a strap is used to form a wireless transponder without operatively coupling RFID transponder device 10-1 as shown in FIG. 2 to an antenna. Instead, as described elsewhere herein, a direct electrical connection is made between RFID transponder device 10-1, and in particular strap leads 22, and RFID reader device 12-1 (described in detail below) to enable signals to be communicated between RFID reader device 12-1 and RFID transponder device 10-1 (and in particular chip 18 provided therein) without an air interface. RFID transponder device 10-1 may either be powered from the modulated electromagnetic field provided by RFID reader device 12-1 (known as a passive device), or may contain its own internal power source, such as a battery (known as an active device).

In the exemplary embodiment, RFID transponder device 10-1 is a passive device powered by the RF signal sent by RFID reader device 12-1. One passive tag technology, known as backscatter technology, generates signals by backscattering the carrier signal sent from the RFID reader. In another technology, described in U.S. Pat. Nos. 6,289,237, 6,615,074, 6,856,291, 7,057,514, and 7,084,605 (and commonly referred to as energy harvesting), RF energy from the RFID reader is harvested and converted to a DC voltage by an antenna/matching circuit/charge pump combination. The DC voltage is then used to power the circuitry that transmits information to the RFID reader at, for example, a different frequency.

FIG. 4 is a schematic representation of one particular, non-limiting embodiment wherein passive technology in the form of energy harvesting as just described is employed to power chip 18 of RFID transponder device 10-1. As seen in FIG. 4, chip 18 of the present embodiment includes energy harvesting circuitry 24 that is operatively coupled to on-board electronic circuitry 26, which in turn is operatively coupled to transmitter circuitry 28. In operation, energy harvesting circuitry 24 is structured to receive RF energy from RFID reader device 12-1 and harvest energy therefrom by converting the received RF energy into DC energy, e.g., a DC voltage. The DC voltage is then used to power on-board electronic circuitry 26 and transmitter circuitry 28. Transmitter circuitry 28 is structured to transmit an RF information signal to RFID reader device 12-1. On-board electronic circuitry 26 may include, for example, control circuitry, such as a microprocessor, a microcontroller or some other suitable custom control circuitry, an associated memory, and additional logic circuitry.

In the particular embodiment shown in FIG. 4, energy harvesting circuitry 24 of chip 18 includes a matching network 30 electrically connected to strap leads 22. Matching network 30 is also electrically connected to a voltage boosting and rectifying circuit preferably in the form of a one or more stage charge pump 32. Charge pumps are well known in the art. Basically, one stage of a charge pump increases the effective amplitude of an AC input voltage with the resulting increased DC voltage appearing on an output capacitor. Successive stages of a charge pump, if present, will essentially increase the voltage from the previous stage resulting in an increased output voltage. In operation, strap leads 22 receive RF energy that is transmitted by RFID reader device 12-1 as described herein. The received RF energy is provided, in the form of an AC signal, to charge pump 32 through the associated matching network 30. Charge pump 32 rectifies the received AC signal to produce a DC signal that is amplified as compared to what it would have been had a simple rectifier been used. In the exemplary embodiment, matching network 30 is chosen (i.e., its impedance is chosen) so as to maximize some criterion such as the voltage of the DC signal output by charge pump 32.

Referring again to FIG. 3, RFID reader device 12-1 of the present, non-limiting exemplary embodiment will now be described. As noted elsewhere herein and as described in detail below, RFID reader device 12-1 is able to read information from and write information to RFID transponder device 10-1 by making a direct (i.e., non-air interface) electrical connection thereto. RFID reader device 12-1 includes a control system 34 and a radio module 36. In the exemplary embodiment shown in FIG. 3, control system 34 includes a processor 3R, such as a microcontroller or microprocessor, and a digital signal processor (DSP) 40, although other configurations are possible. Processor 38 provides control over high level operation of RFID reader device 12-1 and may communicate with an external network and/or peripheral devices such as, without limitation, I/O apparatus 42 (which enables information to be input into and output from RFID reader device 12-1). I/O apparatus 42 may include a display, a keyboard, a touchscreen, or some combination thereof. DSP 40 provides direct control over all operations of radio module 36 in response to high level commands provided by processor 38, and processes data signals received from RFID transponder device 10-1 as described herein. Radio module 36 is adapted to provide for communications to/from RFID transponder device 10-1 by generating and receiving RF signals in the manner described herein.

More particularly, radio module 36 further comprises a transmitter portion 44, a receiver portion 46, and a hybrid 48. Hybrid 48 may further comprise a circulator. Transmitter portion 44 preferably includes a local oscillator that generates an RF carrier frequency. Transmitter portion 44 sends a transmission signal modulated by the RF carrier frequency to hybrid 48, which in turn passes the signal to a touch probe device 50. Hybrid 48 connects transmitter portion 44 and receiver portion 46 to touch probe device 50 while isolating them from each other. In particular, hybrid 48 allows a relatively strong signal to, be sent from transmitter portion 44 while simultaneously receiving a weaker signal reflected from RFID transponder device 10-1. Touch probe device 50 includes one or more electrical contacts or electrodes that are adapted to be selectively and temporarily mated and brought into electrical contact with strap leads 22 of RFID transponder device 10-1. As such, the signals generated by RFID reader device 12-1, that would in known RFID readers be sent over an air interface, may instead be directly transmitted to RFID transponder device 10-1, and thus chip 18 provided therein. Similarly, the signals generated by chip 18, that in the prior art would have been sent via antenna over an air interface to an RFID reader, may instead be directly transmitted to RFID reader device 12-1 through touch probe device 50. In one particular embodiment, touch probe device 50 is wand-like device having two conductors fixed at the end thereof with a center to center distance to accommodate the spacing of strap leads 22 shown in FIG. 2. In this embodiment, the wand-like touch probe device 50 is used to manually bring the conductors into contact with strap leads 22 as needed. It is worth noting that the same wand-like touch probe device 50 may be used to make a transcutaneous contact with an RFID tag implanted along with a medical implant as described elsewhere herein. In another particular embodiment, touch probe device 50 comprises a slot provided in a housing of RFID reader device 12-1 that supports two spring loaded conductors with a center to center distance to accommodate the spacing of strap leads 22. In this embodiment, implant card 8 may be inserted into the slot, wherein the spring loaded conductors will be caused to come into contact with strap leads 22. Still another embodiment may include both types of touch probe devices 50 just described.

The signals from RFID transponder device 10-1 transmitted through touch probe device 50 are passed back to hybrid 48, which forwards the signals to receiver portion 46. Receiver portion 46 mixes the captured signals with the RF carrier frequency generated by the local oscillator to directly downconvert the captured signals to a baseband information signal, which is provided to DSP 40 for processing thereby.

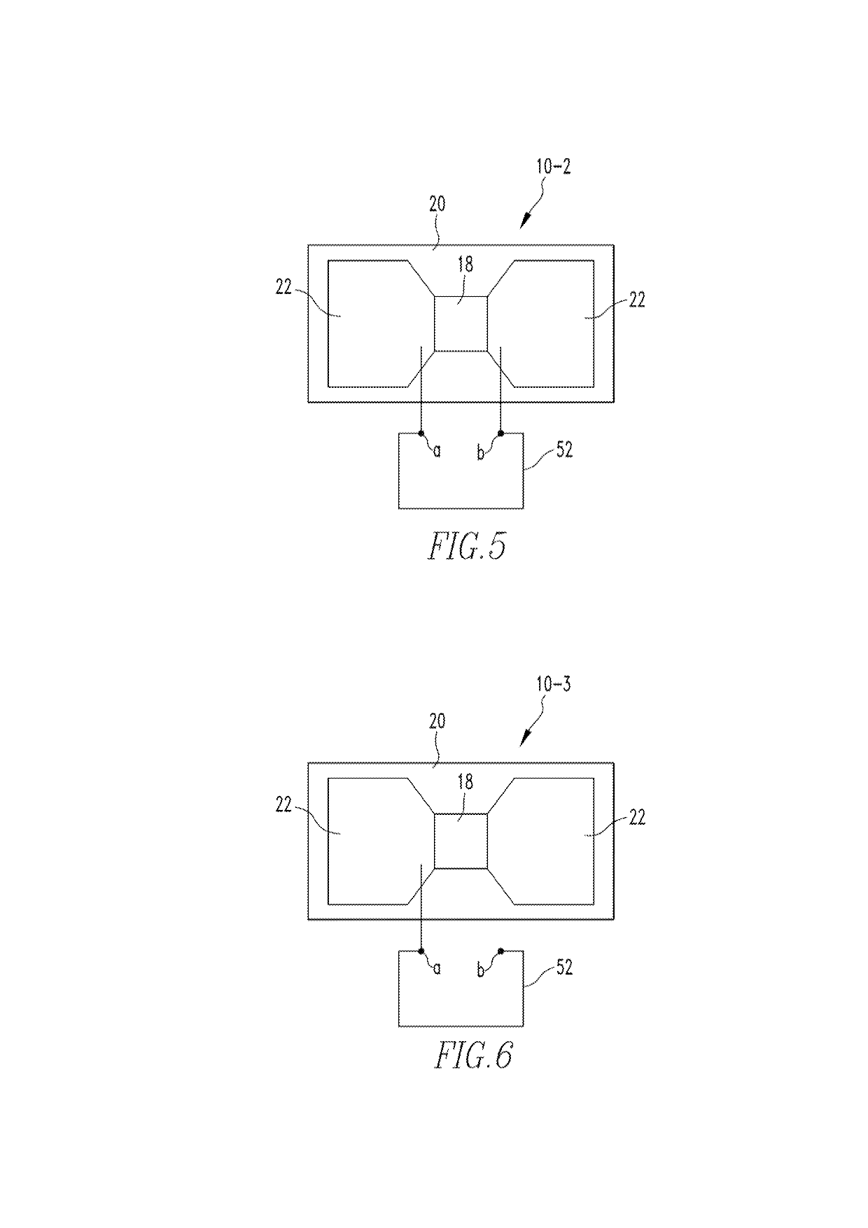

FIG. 5 is a schematic representation of an RFID transponder device 10, labeled 10-2, according to an alternative particular exemplary embodiment that may be employed in implant card 8 to implement system 2. Like RFID transponder device 10-1, RFID transponder device 10-2 is in the form of a strap, and like parts are labeled with like reference numerals. RFID transponder device 10-2 is configured to allow chip 18 included therein to communicate (as described elsewhere herein) with an implementation of RFID reader device 12-1 that includes a touch probe 50 having a single electrical contact (a mono-probe). In particular, in RFID transponder device 10-2, strap leads 22 are operatively coupled to an antenna 52 wherein a terminal a of antenna 52 is coupled to one strap lead 22 and terminal b of antenna 52 is coupled to the other strap lead 22. With such a configuration, a direct electrical connection may be made between RFID transponder device 10-2, and in particular one of the strap leads 22, and the mono-probe of RFID reader device 12-1 to enable signals to be communicated between RFID reader device 12-1 and RFID transponder device 10-2 (and in particular chip 18 provided therein). FIG. 6 is a schematic representation of an RFID transponder device 10, labeled 10-3, according to another alternative particular exemplary embodiment that may be employed in implant card 8 to implement system 2. RFID transponder device 10-3 is similar to RFID transponder device 10-2, except that while terminal a of antenna 27 is connected to one of the strap leads 22, terminal b of the antenna 27 is not connected to the other strap lead 22. RFID transponder devices 10-2 and 10-3 may either be powered from the modulated electromagnetic field provided by RFID reader device 12-1, or may contain its own internal power source, such as a battery.

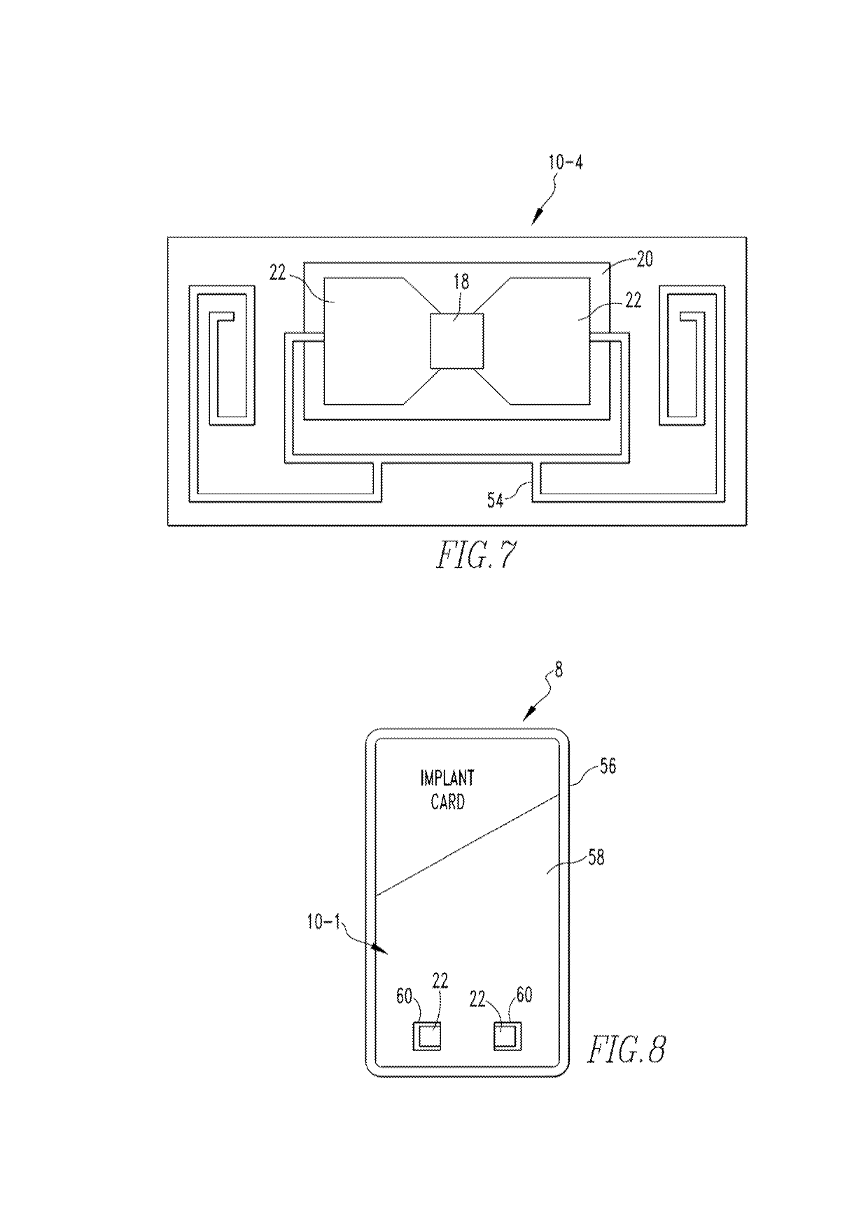

FIG. 7 is a schematic representation of an RFID transponder device 10, labeled 10-4, according to still another alternative particular exemplary embodiment that may be employed in implant card 8 to implement system 2. RFID transponder device 10-4 is in the form of an inlay. In particular, in RFID transponder device 10-4, strap leads 22 are operatively coupled to an antenna 54. As a result, RFID transponder device 10-4 is configured to allow chip 18 included therein to communicate (as described elsewhere herein) with RFID reader device 12-1 (including a touch probe 50) by making direct contact thereto, or with a conventional RFID reader over an air interface.

FIG. 8 is a front isometric view of implant card 8 according to one particular embodiment. A seen in FIG. 8, implant card 8 includes a main body 56 which provides a housing for holding RFID transponder device 10, which in the illustrated embodiment is RFID transponder device 10-1 (although other embodiments may also be used). Main body 56 includes a top surface 58 having a pair of holes 60. As seen in FIG. 8, each hole 60 is aligned with a respective one of the strap leads 22 so that they may be directly engaged by touch probe 50 of RFID reader device 12-1. The rest of RFID transponder device 10-1 (including chip 18) is covered and protected by top surface 58.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system for storing information relating to a medical implant device implanted in a patient, comprising:
a card device structured to be carried by the patient external to the patient's body, the card device including a wireless transponder device, the wireless transponder device securely storing information relating to at least one of the medical implant and the patient; and
a reader device structured to selectively and securely read the information from the wireless transponder device.

2. The system according to claim 1, wherein the information includes at least one of a type/model/serial number of the medical implant, a manufacturer of the medical implant, a date on which the medical implant was surgically implanted, a location where the medical implant was surgically implanted, and a name of a surgeon that surgically implanted the medical implant.

3. The system according to claim 2, wherein the information includes a type/model/serial number of the medical implant, a manufacturer of the medical implant, a date on which the medical implant was surgically implanted, a location where the medical implant was surgically implanted, and a name of a surgeon that surgically implanted the medical implant.

4. The system according to claim 2, wherein the information further includes follow-up examination details by a physician, a physical therapist or an ancillary health care provider.

5. The system according to claim 2, wherein the information further includes information collected by a sensing device internal or external to a body of the patient.

6. The system according to claim 1, wherein the medical implant is an orthopedic implant, a cardiac implant, a dental implant, a general surgical implant, a neurological implant, a gastrointestinal implant, a urological implant, or a gynecological implant.

7. The system according to claim 1, wherein the reader device includes a touch probe structured to enable the reader device to selectively and securely read the information from the wireless transponder device through a direct electrical connection not over an air interface between the touch probe having one or more probe contacts and one or more contacts of the wireless transponder device.

8. The system according to claim 7, wherein the wireless transponder device is an RFID transponder device and wherein the reader device is an RFID reader device.

9. The system according to claim 8, wherein the wireless transponder device is an RFID strap and wherein the one or more contacts are one or more strap leads.

10. The system according to claim 7, wherein the card device includes a main body which provides a housing for holding the wireless transponder device, wherein the main body includes a top surface having one or more of holes, each of the holes being aligned with a respective one of the one or more contacts of the wireless transponder device so that the one or more contacts may be directly engaged by the touch probe.

11. The system according to claim 1, wherein the wireless transponder device is an RFID transponder device and wherein the reader device is an RFID reader device.

12. The system according to claim 1, further comprising a computer system and a secure patient database coupled to the reader device for storing at least part of the information after being read by the reader device.

13. The system according to claim 1, wherein the reader device is also structured to selectively and securely write additional information to the wireless transponder device.

14. The system according to claim 1, wherein the reader device includes a wand-like touch probe structured to enable the reader device to selectively and securely read the information from the wireless transponder device through a direct electrical connection not over an air interface between one or more first probe contacts of the wand-like touch probe and one or more contacts of the wireless transponder device, and wherein the reader device includes a slot touch probe device provided in a housing thereof and structured to enable the reader device to selectively and securely read the information from the wireless transponder device through a direct electrical connection not over an air interface between one or more spring loaded second probe contacts provided in the slot touch probe device and one or more contacts of the wireless transponder device.

15. A card device for storing information relating to a medical implant device implanted in a patient, comprising:
a main body structured to be carried by the patient external to the patient's body; and
a wireless transponder device carried by the main body, the wireless transponder device securely storing information relating to at least one: of the medical implant and the patient and being structured to be selectively and securely read by a reader device.

16. The card device according to claim 15, wherein the information includes at least one of a type/model/serial number of the medical implant, a manufacturer of the medical implant, a date on which the medical implant was surgically implanted, a location where the medical implant was surgically implanted, and a name of a surgeon that surgically implanted the medical implant.

17. The card device according to claim 16, wherein the information includes a type/model/serial number of the medical implant, a manufacturer of the medical implant, a date on which the medical implant was surgically implanted, a location where the medical implant was surgically implanted, and a name of a surgeon that surgically implanted the medical implant.

18. The card device according to claim 16, wherein the information further includes follow-up examination details by a physician, a physical therapist or an ancillary health care provider.

19. The card device according to claim 16, wherein the information further includes information collected by a sensing device internal or external to a body of the patient.

20. The card device according to claim 15, wherein the medical implant is an orthopedic implant, a cardiac implant, a dental implant, a general surgical implant, a neurological implant, a gastrointestinal implant, a urological implant, or a gynecological implant.

21. The card device according to claim 15, wherein the wireless transponder device includes one or more contacts, and wherein the reader device includes a touch probe structured to enable the reader device to selectively and securely read the information from the wireless transponder device through a direct electrical connection not over an air interface between the touch probe having one or more probe contacts and the one or more contacts of the wireless transponder device.

22. The card device according to claim 21, wherein the wireless transponder device is an RFID transponder device and wherein the reader device is an RFID reader device.

23. The card device according to claim 22, wherein the wireless transponder device is an RFID strap and wherein the one or more contacts are one or more strap leads.

24. The card device according to claim 21, wherein the main body provides a housing for holding the wireless transponder device, wherein the main body includes a top surface having one or more of holes, each of the holes being aligned with a respective one of the one or more contacts of the wireless transponder device so that the one or more contacts may be directly engaged by the touch probe.

25. The card device according to claim 15, wherein the wireless transponder device is an RFID transponder device and wherein the reader device is an RFID reader device.

26. A method for storing information relating to a medical implant device implanted in a patient, comprising:
securely storing information relating to at least one of the medical implant and the patient in a wireless transponder device carried by a card device structured to be carried by the patient external to the patient's body; and
selectively and securely reading the information from the wireless transponder device using a reader device.

27. The method according to claim 26, wherein the information includes at least one of a type/model/serial number of the medical implant, a manufacturer of the medical implant, a date on which the medical implant was surgically implanted, a location where the medical implant was surgically implanted, and a name of a surgeon that surgically implanted the medical implant.

28. The method according to claim 27, wherein the information includes a type/model/serial number of the medical implant, a manufacturer of the medical implant, a date on which the medical implant was surgically implanted, a location where the medical implant was surgically implanted, and a name of a surgeon that surgically implanted the medical implant.

29. The method according to claim 27, wherein the information further includes follow-up examination details by a physician, a physical therapist or an ancillary health care provider.

30. The method according to claim 27, wherein the information further includes information collected by a sensing device internal or external to a body of the patient.

31. The method according to claim 26, wherein the medical implant is an orthopedic implant, a cardiac implant, a dental implant, a general surgical implant, a neurological implant, a gastrointestinal implant, a urological implant, or a gynecological implant.

32. The method according to claim 26, wherein the reader device includes a touch probe, and wherein the reading the information from the wireless transponder device using a reader device includes reading the information from the wireless transponder device through a direct electrical connection not over an air interface between the touch probe having one or more probe contacts and one or more contacts of the wireless transponder device.

33. The method according to claim 32, wherein the wireless transponder device is an RFID transponder device and wherein the reader device is an RFID reader device.

34. The method according to claim 33, wherein the wireless transponder device is an RFID strap and wherein the one or more contacts are one or more strap leads.

35. The method according to claim 32, wherein the card device includes a main body which provides a housing for holding the wireless transponder device, wherein the main body includes a top surface having one or more of holes, each of the holes being aligned with a respective one of the one or more contacts of the wireless transponder device so that the one or more contacts may be directly engaged by the touch probe.

36. The method according to claim 26, wherein the wireless transponder device is an RFID transponder device and wherein the reader device is an RFID reader device.

37. The method according to claim 26, further comprising transmitting at least part of the information after being read by the reader device from the reader device to a computer system coupled to a secure patient database.

38. The method according to claim 26, further comprising selectively and securely writing additional information to the wireless transponder device.
